(19) United States
(12) Patent Application Publication
(10) Pub. No.: US 2004/0076150 A1
(43) Pub. Date: Apr. 22, 2004

(54) Method and apparatus for storing a media file

(76) Inventor: Kai X. Miao, (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/274,208

(22) Filed: Oct. 17, 2002

(51) Int. Cl. H04L 12/56

(52) U.S. Cl. 370/389; 370/466

(57) ABSTRACT

A method and apparatus to store a media file are described.

### BACKGROUND

A Voice Over Packet (VOP) network may be a packet network designed to carry various types of media information, such as voice information traditionally carried by a circuit-switched network. A VOP network typically focuses on communicating voice information during an interactive call connection, such as a telephone call. With the increasing popularity of various media services, such as voice messaging, there may be an increasing need to store voice information in a VOP network prior to playback. The amount of voice information for a particular message, however, may consume large amounts of storage memory. Consequently, this may increase overall costs for a VOP network. Accordingly, there may be a need to store voice information in a manner that reduces storage memory requirements as compared to conventional storage technology.

### BRIEF DESCRIPTION OF THE DRAWINGS

The subject matter regarded as embodiments of the invention is particularly pointed out and distinctly claimed in the concluding portion of the specification. Embodiments of the invention, however, both as to organization and method of operation, together with objects, features, and advantages thereof, may best be understood by reference to the following detailed description when read with the accompanying drawings in which:

FIG. 1 is a system suitable for practicing one embodiment of the invention.

FIG. 2 is a block diagram of a processing system in accordance with one embodiment of the invention.

FIG. 3 is a block flow diagram of operations performed by a Voice Storage Module (VSM) in accordance with one embodiment of the invention.

### DETAILED DESCRIPTION

The embodiments of the invention may be directed to storing a media file in a network for playback at a later time. In one embodiment, a network device may receive a plurality of real-time packets carrying voice information. The term “real-time” as used herein may refer to the time during an interactive call connection, such as a telephone conversation between two parties or one party and an automated system. The packets may be compressed for real-time transport over a packet network to another network device. An example of a packet network may comprise the Internet. In one embodiment of the invention, a media server may collect the compressed real-time packets and form a media file. The media server may store the media file for playback at a later time. Playback may be implemented at any conventional playback device. Depending on the compression technology used, the storage memory for the media file may be reduced by approximately 45% or more.

Storing compressed real-time voice information as a media file may provide several advantages. For example, real-time voice information is typically transported as real-time voice packets in a network in accordance with several communication protocols. It may be desirable to store the real-time voice packets for playback at a later time. Each packet, however, may contain control information needed to implement each communication protocol. In some instances, the amount of control information carried by a packet may be significant, depending on the type and number of protocols used to communicate the real-time packets. In fact, there may be instances where the amount of control information carried by a packet may exceed the media data carried by the packet. The control information, therefore, may constitute significant overhead that makes storing a real-time voice packet expensive in terms of consumed storage memory. The embodiments attempt to reduce this overhead by compressing the control information for real-time voice packets, collecting the compressed real-time voice packets into a media file, and storing the media file for playback at a later time.

It is worthy to note that any reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Numerous specific details may be set forth herein to provide a thorough understanding of the embodiments of the invention. It will be understood by those skilled in the art, however, that the embodiments of the invention may be practiced without these specific details. In other instances, well-known methods, procedures, components and circuits have not been described in detail so as not to obscure the embodiments of the invention. It can be appreciated that the specific structural and functional details disclosed herein may be representative and do not necessarily limit the scope of the invention.

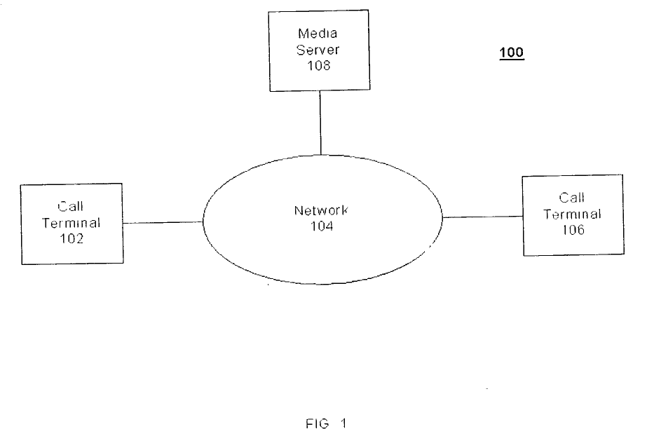

Referring now in detail to the drawings wherein like parts are designated by like reference numerals throughout, there is illustrated in FIG. 1 a system suitable for practicing one embodiment of the invention. FIG. 1 is a block diagram of a system 100. System 100 may comprise, for example, call terminal 102, call terminal 106, and media server 108, all connected by a network 104. Network 104 may comprise, for example, a packet network such as the Internet.

A call terminal may be any device capable of communicating media information over a packet network. A call terminal may comprise, for example, a packet telephony telephone, a computer equipped with a speaker and microphone, a wireless telephone, a portable or handheld computer equipped with a transceiver and modem, a personal digital assistant (PDA) and so forth. In one embodiment of the invention, for example, call terminals 102 and 106 may be a computer equipped with a speaker and microphone. Call terminals 102 and 106 may further include the appropriate hardware and software to perform a VOP telephone call over a packet network such as the Internet. The appropriate hardware and software may include, for example, a modem, network interface card, VOP application software, configuration information and so forth.

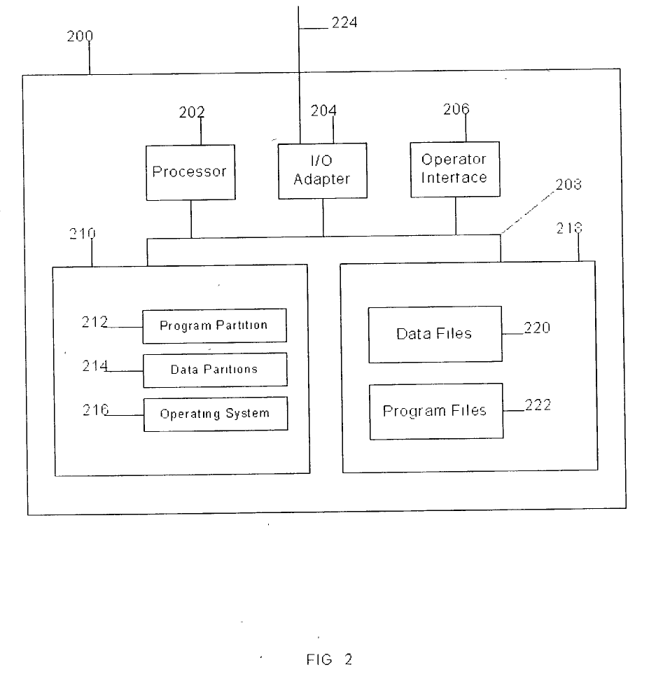

FIG. 2 illustrates a processing system in accordance with one embodiment of the invention. In one embodiment of the invention, a processing system 200 may be representative of any of the devices shown as part of system 100, including call terminals 102 and 106, as well as media server 108. As shown in FIG. 2, system 200 includes a processor 202, an input/output (I/O) adapter 204, an operator interface 206, a memory 210 and a disk storage 218. Memory 210 may store computer program instructions and data. The term “program instructions” may include computer code segments comprising words, values and symbols from a predefined computer language that, when placed in combination according to a predefined manner or syntax, cause a processor to perform a certain function. Examples of a computer language may include C, C++, JAVA, assembly and so forth. Processor 202 executes the program instructions, and processes the data, stored in memory 210. Disk storage 218 stores data to be transferred to and from memory 210. I/O adapter 204 communicates with other devices and transfers data in and out of the computer system over connection 224. Operator interface 206 may interface with a system operator by accepting commands and providing status information. All these elements are interconnected by bus 208, which allows data to be intercommunicated between the elements.

I/O adapter 204 may comprise a network adapter, network interface card (NIC) and/or modem configured to operate with any suitable technique for controlling communication signals between computer or network devices using a desired set of communications protocols, services and operating procedures, for example. I/O adapter 204 also includes appropriate connectors for connecting I/O adapter 204 with a suitable communications medium. I/O adapter 204 may receive communication signals over any suitable medium such as copper leads, twisted-pair wire, co-axial cable, fiber optics, radio frequencies, and so forth.

In one embodiment of the invention, I/O adapter 204 may operate in accordance with one or more communication protocols. In one embodiment of the invention, for example, I/O adapter 204 may operate in accordance with the Transmission Control Protocol (TCP) as defined by the Internet Engineering Task Force (IETF) standard 7, Request For Comment (RFC) 793, adopted in September, 1981 (“TCP Specification”); the Internet Protocol (IP) as defined by the IETF standard 5, RFC 791, adopted in September, 1981 (“IP Specification”); the User Datagram Protocol (UDP) as defined by IETF standard 6, RFC 768, adopted in August 1980 (“UDP Specification”); the Real Time Transport Protocol (RTP) as defined by the IETF proposed standard, RFC 1889, dated January 1996 (“RTP Specification”); and Compressed RTP (CRTP) protocol as defined by the IETF Proposed Standard, RFC 2508, dated February 1999 (“CRTP Specification”), all available from “www.ictf.org.” Although various protocols are described herein for illustrations purposes, it may be appreciated that any number of communication protocols may be used with the various embodiments and still fall within the scope of the invention.

Processor 202 can be any type of processor capable of providing the speed and functionality required by the embodiments of the invention. For example, processor 202 could be a processor from a family of processors made by Intel Corporation, Motorola Incorporated, Sun Microsystems Incorporated, Compaq Computer Corporation and others. Processor 202 may also comprise a digital signal processor (DSP) and accompanying architecture, such as a DSP from Texas Instruments Incorporated. Processor 202 may further comprise a dedicated processor such as a network processor, embedded processor, micro-controller, controller and so forth.

In one embodiment of the invention, memory 210 and disk storage 218 may comprise a machine-readable medium and may include any medium capable of storing instructions adapted to be executed by a processor. Some examples of such media include, but are not limited to, read-only memory (ROM), random-access memory (RAM), programmable ROM, erasable programmable ROM, electronically erasable programmable ROM, dynamic RAM, magnetic disk (e.g., floppy disk and hard drive), optical disk (e.g., CD-ROM) and any other media that may store digital information. In one embodiment of the invention, the instructions are stored on the medium in a compressed and/or encrypted format. As used herein, the phrase “adapted to be executed by a processor” is meant to encompass instructions stored in a compressed and/or encrypted format, as well as instructions that have to be compiled or installed by an installer before being executed by the processor. Further, system 200 may contain various combinations of machine-readable storage devices through various I/O controllers, which are accessible by processor 202 and which are capable of storing a combination of computer program instructions and data.

Memory 210 is accessible by processor 202 over bus 208 and includes an operating system 216, a program partition 212 and a data partition 214. In one embodiment of the invention, operating system 216 may comprise an operating system sold by Microsoft Corporation, such as Microsoft Windows® 95, 98, 2000 and NT, for example. Program partition 212 stores and allows execution by processor 202 of program instructions that implement the functions of each respective system described herein. Data partition 214 is accessible by processor 202 and stores data used during the execution of program instructions. In one embodiment, program partition 212 contains program instructions that will be collectively referred to herein as a Voice Storage Module (VSM). This module may create a media file, store a media file, transfer a media file or playback a media file in accordance with the embodiments described herein. Of course, the scope of the invention is not limited to this particular set of instructions.

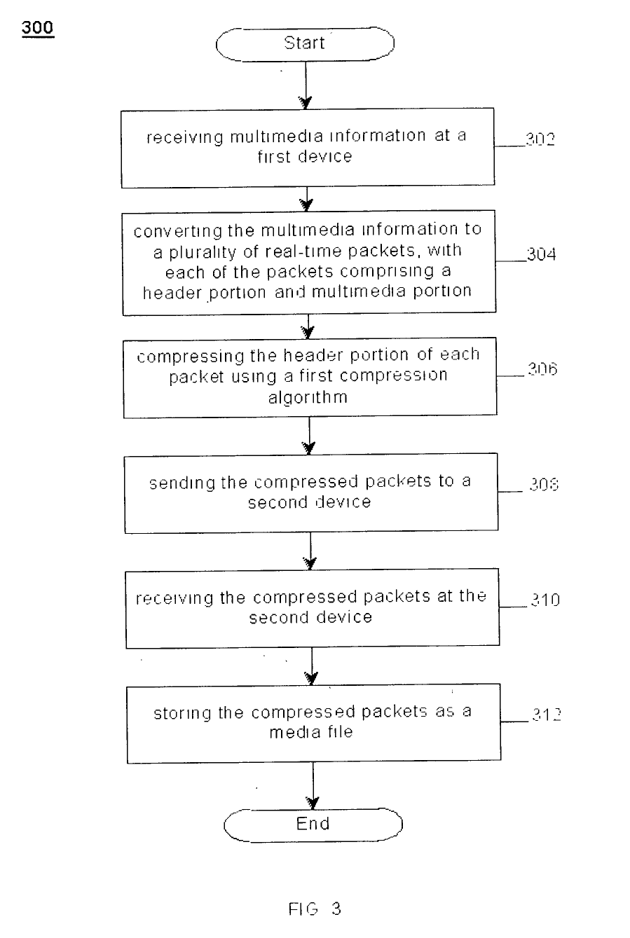

The operation of systems 100 and 200 may be further described with reference to FIG. 3 and accompanying examples. Although FIG. 3 as presented herein may include a particular processing logic, it can be appreciated that the processing logic merely provides an example of how the general functionality described herein can be implemented. Further, each operation within a given processing logic does not necessarily have to be executed in the order presented unless otherwise indicated.

FIG. 3 is a block flow diagram of the operations performed by a VSM in accordance with one embodiment of the invention. In one embodiment of the invention, this and other modules may refer to the software and/or hardware used to implement the functionality for one or more embodiments as described herein. In this embodiment of the invention, these modules may be implemented as part of a processing system, such as processing system 200. It can be appreciated that this functionality, however, may be implemented by any device, or combination of devices, located anywhere in a communication network and still fall within the scope of the invention.

FIG. 3 illustrates a programming logic 300 for a VSM in accordance with one embodiment of the invention. More particularly, programming logic 300 illustrates programming logic to store a media file. Multimedia information may be received a first device at block 302. An example of the first device may be a call terminal. The multimedia information may be converted to a plurality of real-time packets at block 304. An example of real-time packets may be packets created in accordance with the RTP Specification. Each the packets may comprise a header portion and multimedia portion. The header portion of each packet may be compressed using a first compression algorithm at block 306. An example of a first compression algorithm may be the compression algorithm consistent with the CRTP Specification. The compressed packets may be sent to a second device at block 308. An example of a second device may be a media server. The second device may receive the compressed packets at block 310. The compressed packets may be stored as a media file at block 312.

In one embodiment of the invention, the multimedia information may comprise voice information. In another embodiment of the invention, the multimedia information may comprise video information. The embodiments, however, are not limited in this context.

In one embodiment of the invention, the packets may be communicated over a packet network using one or more communication protocols. The header portion may comprise control information for such protocols. The control information may comprise, for example, the control information consistent with the IP Specification, UDP Specification and RTP Specification.

In one embodiment of the invention, a request may be received the play the media file. The media server may retrieve packets from the media file, and send the packets to a third device. An example of a third device may be another call terminal. The packets may be received at the third device, and converted to the multimedia information. The third device may then play out the multimedia information.

In one embodiment of the invention, a request may be received to transfer the media file from the media server to a third device. The entire media file may be sent to the third device via one or more transfer protocols, e.g., the File Transfer Protocol. The third device may then retrieve packets from the media file, convert the packets to the original multimedia information, and play out the multimedia information.

In one embodiment of the invention, the multimedia portion of each packet may be compressed using a second compression algorithm. An example of a second compression algorithm may be a voice compression algorithm such as the G729A voice compression algorithm. The compressed packets may then be sent to the second device.

The operation of systems 100 and 200, and the processing logic shown in FIG. 3, may be better understood by way of example. In operation, assume an operator of call terminal 102 desires to initiate a VOP telephone call via network 104 to call terminal 106. The operator may execute the VOP application software to establish a call connection with call terminal 106. Call terminal 102 may begin the call connection setup process by communicating control information to call terminal 106. During the call connection setup process, the operator of call terminal 102 may hear the normal acoustical feedback indicating the current state of the call connection setup process, e.g., receiving a dial tone, ring tones and so forth. Assume that the operator of call terminal 106 is not available, and the call is redirected to an automated voice mail system residing as part of media server 108. A call connection may be completed between call terminal 102 and media server 108.

Once the call connection has been established, the operator of call terminal 102 may begin to record a voice message for the operator of call terminal 106. The operator may begin speaking into a microphone of call terminal 102. Call terminal 102 receives the voice information and begins converting the voice information from analog signals to packets of digital signals. Each packet may comprise a portion of the voice information and some control information for the packet. The control information is typically part of the header, and may represent various control instructions for the packet. For example, the header may contain routing information to route the packets to the proper destination, e.g., media server 108. The header may also include RTP control information. RTP is a protocol designed for keeping track of timing and sequence information of real-time packets so that the receiver can recover the correct sequence and time of speech data.

The amount of control information for a particular protocol may be significant. For example, an RTP header in an RTP packet may be 12 bytes, where compressed speech data in an RTP packet may be as low as 10 bytes, or in some cases as little as 2 bytes, e.g., a Silence Indication Descriptor (SID). Combined with the control information for the IP Specification and UDP Specification, and the size of the combined header for each packet may be as large as 40 bytes. The header for a real-time voice packet may therefore introduce significant overhead for each packet, therefore requiring large amounts of memory for storing each real-time packet.

To solve this problem, the combined IP/UDP/RTP header of 40 bytes may be compressed to a smaller number of bytes using a compression algorithm. For example, the CRTP compression algorithm may reduce the IP/UDP/RTP header of 40 bytes to as low as 2 bytes. The compressed header means that each real-time voice packet may be stored as part of a media file using significantly less memory than conventional solutions.

Once the voice information is converted to packets and compressed, the packets may be sent to media server 108. Media server 108 may receive the compressed packets and store them as a media file. The media file may be played back directly from the media server, or the media file may be transferred to another call terminal and played back from there.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

1. A method to store a media file, comprising:
receiving multimedia information at a first device;
converting said multimedia information to a plurality of real-time packets, with each of said packets comprising a header portion and multimedia portion;
compressing said header portion of each packet using a first compression algorithm;
sending said compressed packets to a second device;
receiving said compressed packets at said second device; and
storing said compressed packets as a media file.

2. The method of claim 1, wherein said multimedia information comprises voice information.

3. The method of claim 1, wherein said multimedia information comprises video information.

4. The method of claim 1, wherein said header comprises control information in accordance with an IP Specification, UDP Specification and RTP Specification.

5. The method of claim 1, wherein said first device is a call terminal.

6. The method of claim 1, wherein said second device is a media server.

7. The method of claim 1, further comprising:
receiving a request to play said media file from a third device;
retrieving packets from said media file;
sending said packets to said third device;
receiving said packets at said third device;
converting said packets to said multimedia information; and
playing said multimedia information.

8. The method of claim 1, further comprising:
receiving a request for said media file from a third device;
sending said media file to said third device;
retrieving said packets from said media file;
converting said packets to said multimedia information; and
playing said multimedia information.

9. The method of claim 1, wherein said real-time packets are made in accordance with an RTP Specification.

10. The method of claim 1, wherein said first compression algorithm operates in accordance with a Compressed Real-Time Transport Protocol (CRTP) Specification.

11. The method of claim 1, further comprising compressing said multimedia portion of each packet using a second compression algorithm prior to sending said compressed packets to said second device.

12. An article comprising:
a storage medium;
said storage medium including stored instructions that, when executed by a processor, result in storing a media file by receiving multimedia information at a first device, converting said multimedia information to a plurality of real-time packets, with each of said packets comprising a header portion and multimedia portion, compressing said header portion of each packet using a first compression algorithm, sending said compressed packets to a second device, receiving said compressed packets at said second device, and storing said compressed packets as a media file.

13. The article of claim 12, wherein the stored instructions, when executed by a processor, further result in receiving a request to play said media file from a third device, retrieving packets from said media file, sending said packets to said third device, receiving said packets at said third device, converting said packets to said multimedia information, and playing said multimedia information.

14. The article of claim 12, wherein the stored instructions, when executed by a processor, further result in receiving a request for said media file from a third device, sending said media file to said third device, retrieving said packets from said media file, converting said packets to said multimedia information, and playing said multimedia information.

15. The article of claim 12, wherein the stored instructions, when executed by a processor, further result in compressing said multimedia portion of each packet using a second compression algorithm prior to sending said compressed packets to said second device.

16. A system, comprising:
a computing platform adapted to store a media file;
said platform being further adapted to receiving multimedia information at a first device, converting said multimedia information to a plurality of real-time packets, with each of said packets comprising a header portion and multimedia portion, compressing said header portion of each packet using a first compression algorithm, sending said compressed packets to a second device, receiving said compressed packets at said second device, and storing said compressed packets as a media file.

17. The system of claim 16, wherein said platform is further adapted to receiving a request to play said media file from a third device, retrieving packets from said media file, sending said packets to said third device, receiving said packets at said third device, converting said packets to said multimedia information, and playing said multimedia information.

18. The system of claim 16, wherein said platform is further adapted to receiving a request for said media file from a third device, sending said media file to said third device, retrieving said packets from said media file, converting said packets to said multimedia information, and playing said multimedia information.

19. The system of claim 16, wherein said platform is further adapted to compressing said multimedia portion of each packet using a second compression algorithm prior to sending said compressed packets to said second device.

20. A method to store a media file, comprising:
receiving voice information at a first call terminal;
converting said voice information to a plurality of real-time packets in accordance with an IP Specification, UDP Specification and RTP Specification, with each of said packets comprising a header and multimedia data;
compressing said header portion of each packet in accordance with a CRTP Specification;
sending said compressed packets to a media server;
receiving said compressed packets at said media server; and
storing said compressed packets as a media file.

21. The method of claim 20, further comprising:
retrieving packets from said media file;
sending said packet to a second call terminal;
converting said packets to said voice information; and
playing said voice information.

22. The method of claim 20, further comprising:
transferring said media file to a second call terminal;
retrieving packets from said media file;
converting said packets to said voice information; and
playing said voice information.
